(19) United States
(12) Patent Application Publication
(10) Pub. No.: US 2004/0071139 A1
(43) Pub. Date: Apr. 15, 2004

(54) Method and apparatus for efficient administration of memory resources in a data network tester

(76) Inventor: Charles James Burnett, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/268,630

(22) Filed: Oct. 10, 2002

(51) Int. Cl. H04L 12/56

(52) U.S. Cl. 370/392

(57) ABSTRACT

A method of administering network performance data comprises the steps of parsing a cell to obtain a stream identifier and calculating network performance data from information in the cell. The method further comprises storing the stream identifier in a content addressable memory (CAM) at a next available address in the CAM and storing the network performance data in a network performance data memory element at an address in the network data memory element that is related to a value of the next available address in the CAM. The process further comprises the steps of obtaining an irrelevant CAM address wherein an entry at the irrelevant CAM address contains a value matching the stream identifier of an irrelevant stream. The process stores a value at the irrelevant CAM address of a sum of the stream identifier and a mask value. The mask value temporarily prevents use of the irrelevant CAM address during a memory element administration process. The process then resets entries in the memory element at addresses that are related to a value of the CAM address, and resets the irrelevant CAM address to reflect future availability.

### BACKGROUND

Data networking is a powerful tool in current communication systems. As data networking has matured and become more prevalent over the years, data protocol complexities and data rates have increased. Asynchronous Transfer Mode (ATM) networks are one of the prevalent data communication protocols currently in use. ATM is a cell-relay technology that divides upper-level data units into 53-byte cells for transmission over a physical medium. It operates independently of the type of transmission being generated at the upper layers and of the type and speed of the physical-layer medium below it. The ATM technology permits transport of transmissions (e.g, data, voice, video, etc.) in a single integrated data stream over any medium, ranging from existing T1/E1 lines to SONET OC-3 at speeds of 155 Mbps. The basic standards that define ATM are ITU-T I.361, which defines the ATM Layer functions, ITU-T I.363 that defines the ATM Adaptation Layer protocols, and ITU-T I.610, which defines the ATM Operation and Maintenance (“OAM”) and the resource management (“RM”) functions.

In order to maintain an ATM data network, it is helpful to have the ability to detect and diagnose problems while the network is running at-speed and without having to disable data communication traffic. A tool that aids in the detection and diagnosis of data communication troubles is the collection and statistical processing of information relating to data traffic over the network. As one of ordinary skill in the art appreciates, collection of raw data is of minimal value without some additional processing of the raw data into information that may be interpreted by a test operator. Data networking statistics help reduce the raw data to information by providing information to a test operator concerning the patterns of data flow.

An ATM stream is typically full duplex. As such, a first physical link carries in-coming cells and a second physical link carries out-going cells. The term stream is used herein to mean a single overall device-to-device communication, which could be a voice conversation, an electronic message, or a video signal. In some cases, a stream will only use communication bandwidth in one direction depending upon the type of signal being transferred. A test instrument, however, does not have a priori knowledge of the type of streams being transferred. The ATM protocol is capable of transmitting all of the different types of streams simultaneously. For maximum flexibility in a data network tester, therefore, it is beneficial to monitor and correlate related streams on the two physical links.

The ATM protocol is capable of transmitting up to approximately 2²⁸ full-duplex streams. In order to administer and reassemble the different streams, an ATM switch assigns a unique stream identifier as part of an ATM segmentation process. The stream identifier comprises two numbers that are referred to as a Virtual Path(“VP”)/Virtual Channel (“VC”) pair. The VP/VC pair is referred to herein as the stream identifier. The stream identifier is placed in the header of the ATM cells that carry data being transferred as part of the stream and provide a mechanism by which the streams are reconciled at the point of re-assembly. At some point in time, the stream finishes, the data transfer is complete, and the stream number is no longer relevant to the communication process.

It is beneficial for a tester that is monitoring the network to maintain coherency between the in-coming and out-going streams. Specifically, the tester should be able to administer and properly relate the various streams on the network. Additionally, it is beneficial for the tester to utilize tester resources most efficiently so as to prevent a data overflow condition.

### SUMMARY

A method of administering network performance data comprises the steps of parsing a cell to obtain a stream identifier and calculating network performance data from information in the cell. The method further comprises storing the stream identifier in a content addressable memory (CAM) at a next available address in the CAM and storing the network performance data in a network performance data memory element at an address in the network data memory element that is related to a value of the next available address in the CAM.

According to another aspect of an embodiment of the claimed invention an apparatus for administering network performance data comprises means for parsing a cell to obtain a stream identifier and means for calculating network performance data from information in the cell. The apparatus further comprises a content addressable memory (CAM) and means for storing the stream identifier in the CAM at a next available address in the CAM. The apparatus also has a network performance data memory and means for storing the network performance data in a network performance data memory element at an address in the network data memory element that is related to a value of the next available address

### BRIEF DESCRIPTION OF THE DRAWINGS

FIG. 1 is an illustration of an ATM data network.

FIG. 2 is a conceptual illustration of ATM network traffic with multiple streams.

FIG. 3 is a block diagram of an embodiment of a test device according to the teachings of the present invention.

FIG. 4 is a block diagram of a line interface module portion of a test device according to the teachings of the present invention.

FIG. 5 is a further detailed view of a portion of FIG. 4 illustrating a use for a content addressable memory (CAM) according to the teachings of the present invention.

FIG. 6 is a flowchart illustrating a process for adding entries to the CAM.

FIG. 7 is a flowchart illustrating a process for deleting entries from the CAM.

### DETAILED DESCRIPTION

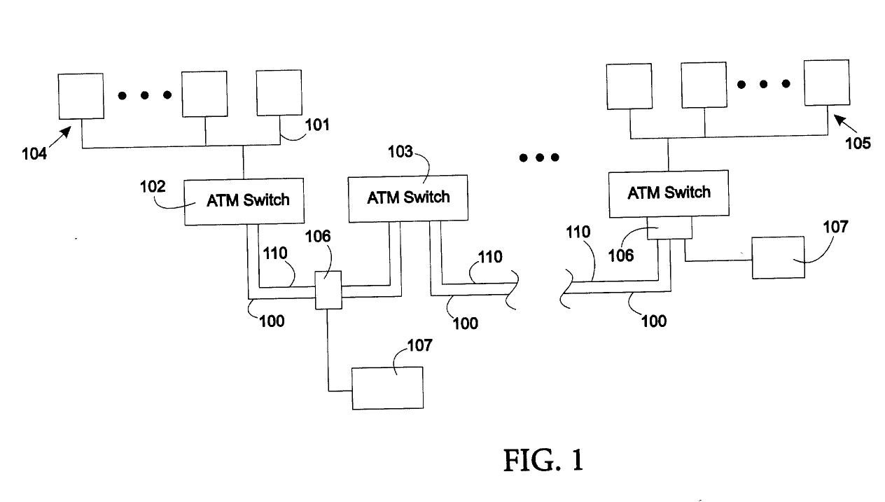

With specific reference to FIG. 1 of the drawings, there is shown an illustration of a representative ATM data network. An ATM network comprises one or more physical cables 100, 110 between first and second ATM switches 102, 103. The physical cables 100, 110 carry electrical or optical data signals to and from the ATM data switches 102, 103. A conventional ATM network is typically a full duplex system that has two dedicated physical cables, one each for the reception 100 and transmission 110 channels. The ATM data switches 102, 103 are often connected to a local network and act as the interface between the ATM network and the local network 104, 105. The ATM data switch 102 or 103 performs segmentation of data from an origination local network 104 into 53 byte cells for transmission across the ATM channel 100 or 110. When the cell reaches a destination ATM switch 103 or 102, the ATM switch 102 or 103 either transmits the cell to a next ATM switch in the circuit or performs reassembly of the cells for presentation to a destination local network 105.

As a practical matter, there are typically on the order of hundreds of streams that are active at any one time on a single ATM network. Other streams are inactive and eventually time out and become irrelevant. Accordingly, as some streams are in the process of timing out, there are on the order of 1500-2000 streams that must be tracked at any one point in time. With this in mind, it is assumed that a test device 107 that is able to track an upper limit of 4096 active streams will be able to adequately handle a worst-case practical scenario. One of ordinary skill in the art appreciates that ATM networks will get faster and be able to accommodate a greater number of streams as technology progresses. Accordingly, the teachings of the present invention may be scaled to accommodate more than the 4096 streams as network and processing capabilities increase.

In order to test an ATM network, a test device probe 106 plugs into the ATM network at any point along its length, either at the cable or cables 100, 110 with a tap or at one or more of the ATM switches 102, 103. The probe 106 eavesdrops onto the data traffic without interfering with transmission of the data on the ATM network in any way. Advantageously, the ATM network may operate at-speed and without any accommodation made for the presence of the probe 106. The probe 106 communicates with a test device 107 that receives and processes the data present on the ATM network.

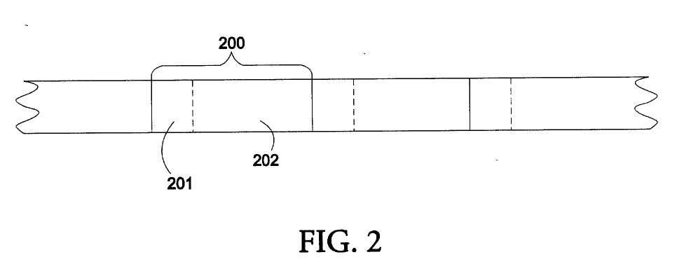

With specific reference to FIG. 2 of the drawings, there is shown a representation of multiple cells 200 present on the ATM network 100, 110. Each cell 200 comprises 53 bytes of information. There are 5 bytes of header 201 and 48 bytes of payload 202. Each cell 200 is part of a unique stream of information. Multiple cells 200 in a single stream represent a single message block from a source device, such as a computer, to a destination device. Additionally, there are operations and maintenance (OAM) cells used to provide various maintenance functions within the ATM network, including connectivity verification and alarm surveillance. Operation and maintenance cells (OAM cells) and resource management cells (RM cells) are 53 bytes, but have logical structures different from the logical structure of the data cells 200. A stream represents a communication from a source device, such as a computer, to a destination device. The ATM protocol is capable of administering the transmission of up to approximately 2²⁸ streams at a time and the cells 200 that make up each unique stream may be transmitted at different rates. The cells 200 that comprise the stream are sent sequentially in time, but may be sent at any rate and at any time. Cells 200 from different streams are interleaved with each other as well as OAM and RM cells during transmission. Accordingly, in order to reassemble cells into a stream, it is necessary to parse and interpret the header information in each cell before appropriately interpreting and then disposing of the payload.

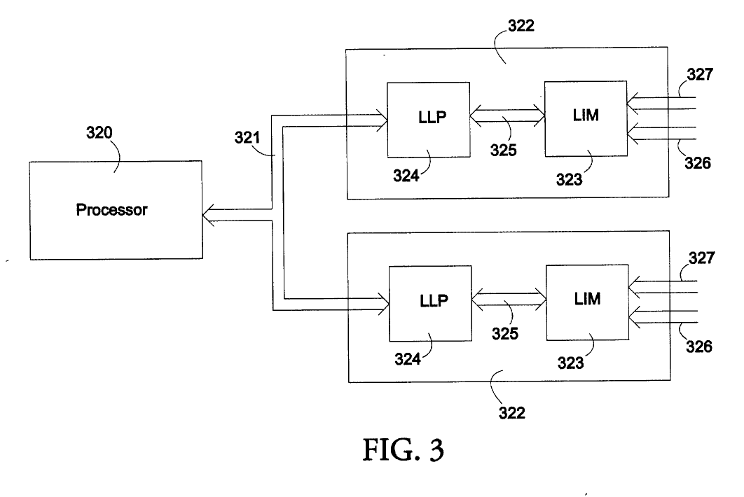

With specific reference to FIG. 3 of the drawings, a test device 107 according to the teachings of the present invention comprises a processor such as a personal computer 320 or equivalent communicating over a communications bus 321 to one or more electronic printed circuit boards (“PCB”) 322. In the embodiment illustrated, the processor 320 and PCBs 322 share a chassis and power supply. The illustration shows two PCBs, however, the number of PCBs is dictated by a user's need and limited by a physical capacity of the chassis. In an alternate embodiment, the internal communications bus may be an external LAN where the processor 320 is remote from the other hardware elements. Referring back to FIG. 3 of the drawings, each printed circuit board 322 contains a line interface module (“LIM”) 323 and a link layer processor (“LLP”) 324. The LIM and the LLP communicate over an internal communications bus 325. The circuitry on each of the PCBs is the same, therefore, only the structure of one PCB is further described. The PCB 322 has two channels. A first channel 326 is connected to the cable 100 carrying incoming cells 200 and a second channel is connected to the cable 110 carrying outgoing data 327. In a specific embodiment, there is a plurality of different PCBs 322 for connections to different types of ATM networks. As an example, a PCB for connection to an optical ATM network has a different configuration and physical connector than that for a connection to an electrical network. The logic contained in the PCBs, however, remains the same.

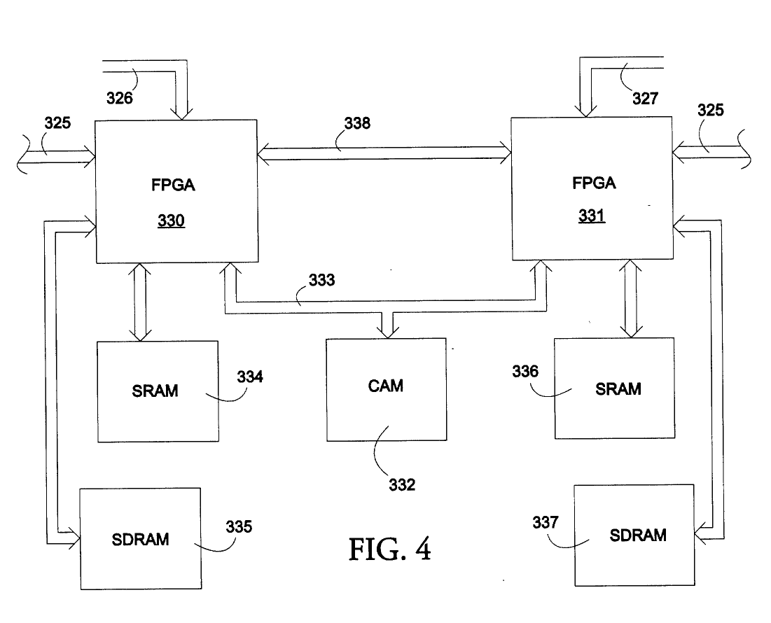

With specific reference to FIG. 4 of the drawings, there is shown a block diagram for the line interface module (“LIM”) 323 present on the PCB 322. The LIM comprises first and second field programmable gate arrays (“FPGAs”), 330 and 331 respectively, that receive the data from the first and second channels 326, 327. The FPGAs are both connected to a single content addressable memory (“CAM”) 332 over a shared CAM bus 333. The first FPGA 330 is also connected to a dedicated first SRAM 334 and first SDRAM 335 memory elements. Similarly, the second FPGA 331 is connected to a dedicated second SRAM 336 and second SDRAM 337 memory elements. The first and second SRAM memory elements 334, 336 are each a single 512 kbyte part that is 16-bits wide and 256 k entries deep, but is logically separated into a global header storage area, an A memory element 301 and a B memory element 302. The A and B memory elements 301, 302 store network performance data for the data network under test. The first and second FPGAs communicate over an FPGA bus 338. The FPGAs are encoded with a front-end tool using a PC running Microsoft's Windows 2000 operating system and applications from Synplicity including a VHDL language and the SynplifyPro compiler/synthesizer software package. A back-end tool includes Foundation software from Xilinx.

The LIM 323 eavesdrops on the ATM network in both the receive and transmit directions, parses the header 201 from the payload 202 of each cell 200, determines to which stream the cell belongs, determines if a particular stream is being tracked, obtains network performance data by counting events, calculating statistics or calculating error check products, such as a Cyclical Redundancy Check (“CRC”) product for the stream over a given period of time, and stores the network performance data into the first SRAM 334 in one of the two logical parallel memory elements, first A memory element 301 or first B memory element 302. Network performance data for the second channel 327 is similarly processed and stored into the second SRAM 336 in one of the two logical parallel memory elements, second A memory element 303 or second B memory element 304. The SRAMs 334, 336 are 512 kbyte memories having an 18-bit address bus and a 16-bit data bus. The A memory elements 301, 303 comprises 128 kbytes of the SRAM 334 or 336 covered by addresses 00000-0FFFFhex. The B memory elements 302, 304 comprise 128 kbytes covered by addresses 10000-1FFFF hex. Addresses 20000-20007 hex store A and B copies of per channel cell counters and addresses 20008-2000D hex store A and B copies of per channel OAM/RM cell counters. The remaining portion of the SRAM 334, 336 holds global configuration information including LIM status information and reserved space for future use. The LLP 324 of the test device 107 then periodically reads and processes the stored network performance data for eventual display on the test device 107. Because there is a significant quantity of network performance data to collect, the SRAM 334, 336 that holds the stored data is large enough so that the sequential reading of either one of the logical memory elements 301 or 302 takes a finite and significant amount of time. The amount of time is significant because the time it takes to read the entire memory element 301 through 304 is greater than the time within which new network performance data may be gathered, calculated as necessary, and made available for storage. Consequently, data for a current time slot must be written to one of the memory elements 301, 302 and 303, 304 before all of the network performance data from the former time slot is retrieved. If network performance data for the former time slot is overwritten during the data retrieval process, then the retrieved data will not reflect a coherent result.

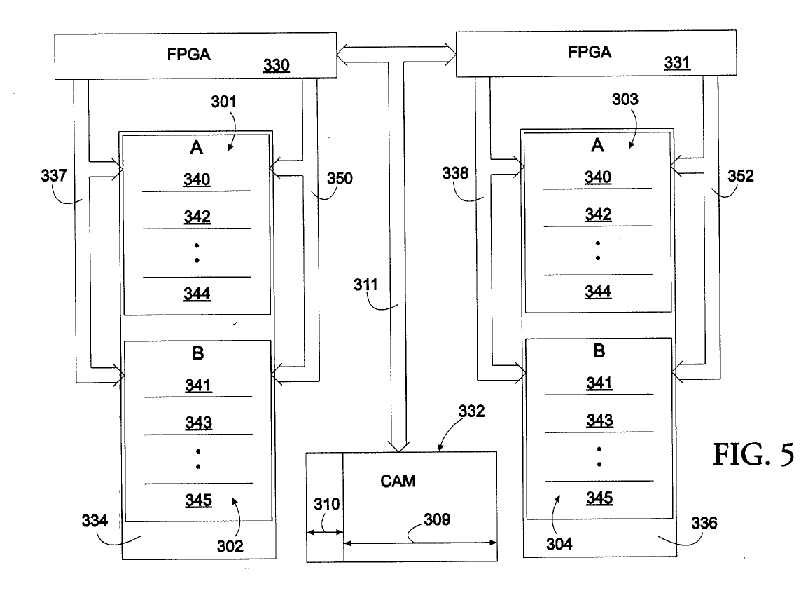

In order to achieve coherency among all of the statistics within a single time slot and with respect to FIG. 5 of the drawings, there is shown the logical A and B memory elements 301, 302 and 303, 304 illustrated as separate and parallel entities. The A and B memory elements 301, 302 and 303, 304 are the same size and have parallel logical structures. As such, an entry in the A memory element 301 is accessed using an address and a corresponding entry in the B memory element 302 is accessed using the same address plus an offset address, which in a specific embodiment is 128 k or 2¹⁷. Words of each memory element 301 through 304 are assigned to contain the network performance data related to specific streams. Addresses 0 through 15 of the A memory elements 301, 303 comprise a first A data block 340. Addresses 0 through 15 plus the offset of the B memory elements 302, 304 comprise a first B data block 341. Each first A and B data block contains two 32-bit words of stream specific configuration information and six 32-bit words representing different numbers of network performance data for stream #1. Because the A and B memory elements 301, 302 are parallel entities, corresponding entries for each memory element 301, 302 hold a number that represents the same type of network performance data. Second A and B data blocks 342, 343, represented by addresses 16 through 31 and addresses 16 through 31 plus an offset of respective first and second memory elements 301, 302, each contains the stream specific configuration information and six numbers of network performance data for stream #2. Third A and B data blocks, representing addresses 32 through 47 of the A and B memory elements 301, 302 and addresses 32 through 47 plus an offset, respectively, each contains stream specific configuration information and six different numbers of network performance data for stream #3, up to nth A and B data blocks 344, 345 containing stream specific configuration information and six different network performance data for stream #n. Each A and B data block 340 thru 345 has a different starting address, which is the address of respective SRAM 334, 336 entries for the first number of network performance data in each data block 340 thru 345. In the specific example, a pattern is established so that the stream number multiplied by 16, or a register shift 4 bits, is equal to the starting address 306 of the stored network performance data in the A memory elements 301, 303 for the stream pertaining to the stream number. Access to the B memory elements 302, 304 is made using the starting address plus the offset. In a preferred embodiment, however, the actual stream number is not used. It is an index of the stream number multiplied by 16 that is equal to the starting address. As one of ordinary skill in the art can appreciate, there may be any number of network performance data entries for storage and provided the pattern is maintained, it is straightforward to obtain the starting address from the stream number for the desired data block. As one of ordinary skill in the art can also appreciate, a single address bit determines if data is stored to the A memory elements 301, 303 or the B memory elements 302, 304.

With specific reference to FIG. 5 of the drawings there is shown a more detailed conceptual illustration of a portion of the LIM 323 showing the two sets of two parallel memory elements first A memory element 301, first B memory element 302, second A memory element 303, and second B memory element 304. The LIM 323 has a single content addressable memory (“CAM”) 332 used for administration of collected network performance data for both channels on the LIM 323. The CAM 332 in a specific embodiment is 32-bits wide, 28 bits of which are an address information field 309. The remaining 4 bits are a control field 310. Only one bit of the control field 310 is used. The remaining 3 bits of the control field 310 are reserved for possible future use. The CAM 332 communicates with the first and second FPGAs 330, 331 over a bi-directional CAM bus 311. The CAM bus 311 carries address, data and control lines to and from the CAM 332 and the FPGAs 330, 331 that control the CAM 332. The FPGAs 330, 331 arbitrate for use of the CAM 332 using a master-slave configuration, so that in the event that both FPGAs 330, 33¹ want access to the CAM 332 at the same time, the first FPGA 330 as master will win access while the second FPGA 331 as slave must wait until the CAM 332 completes its function for the first FPGA 330. The function of the CAM 332 is to provide address information 308 that serves as the index that directs the proper placement of network performance data into the memory elements 301 through 304.

The first A memory element 301 and the first B memory element 302 alternately receive data from an incoming data network channel 326. Specifically, a cell 200 present on the incoming channel 326 is received, buffered, and processed by the first FPGA 330. The processed data is presented as network performance data 337, which are stored in the first A memory element 301 or the second B memory element 302. The second A memory element 303 and the second B memory element 304 alternately receive data from the outgoing channel 327. Specifically, a cell 200 present on the outgoing channel 327 is received, buffered, and processed by the second FPGA 331. The processed data is presented as network performance data 338, which are stored in the second A memory element 303 or the second B memory element 304. The alternate storage method is disclosed in the teachings of patent application entitled “Method and Apparatus of Testing a Data Network” filed Oct. 4, 2002 having serial no. xx/xxx,xxx by the same inventor as the present patent application, the contents of which are hereby incorporated by reference. The data blocks 340 through 345 that comprise the first and second A and B memory elements 301 through 304 are logically segregated into two 32-bit words of configuration information and six 32-bit words of network performance data. The FPGAs 330, 331 access the data blocks 340 through 345 stored in the SRAMs 334, 336, respectively, using SRAM address lines 350, 352 respectively. The configuration information field stores information including the stream identifier value, the protocol of the stream if one is recognized, whether the stream is being tracked by the test device or not, and whether the stream should be reassembled or not. The configuration field also contains additional information that is unimportant to the details of the claimed invention and is beyond the scope of the present disclosure. The configuration information field 312 communicates a status of the stored data to one or more software processes that retrieve and further process the stored data. One of the bits in the configuration information field is a valid stream bit. Respective valid stream bits indicate whether the data stored in the data block 340 through 345 is valid data. In a specific embodiment, the valid stream bit having a “1” value indicates valid data and a “0” value indicates invalid data.

The CAM 332 is used to access the appropriate data block when given a stream identifier. Specifically, a stream identifier is presented to the CAM 332 by the FPGA 330 or 331 over the CAM bus 311 and if a stream identifier has already been recognized by the system, returns a value representing an address in the CAM 332 in which the stream identifier is stored. The storage structure of the CAM 332 is related to the storage structure for the data blocks 340 through 345 so that a stream identifier is stored in a CAM address, where the CAM address is the index that, when multiplied by 16, is equal to the starting address of the data block in the A memory elements 301, 303 and added with the offset is equal to the starting address of the data block in the B memory elements 303, 304 that holds the network performance data for the stream having the specified stream identifier. The FPGA/SRAM 330/334 and 331/336 combinations share the CAM 332. Accordingly, the network performance data for the incoming and outgoing channel is stored in the SRAMs 334 and 336 using the same starting address index.

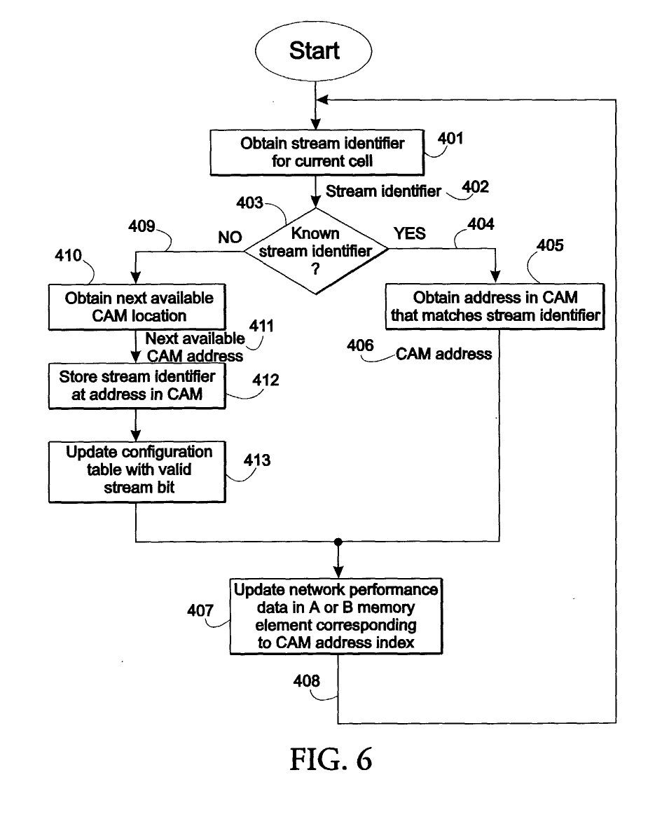

With specific reference to FIG. 6 of the drawings, there is shown a flow chart of an embodiment of a process according to the teachings of the present invention in which information is loaded into the CAM 332. Specifically, as each cell 200 is presented on the network channels 326, 327, the cell 200 is stored and processed by respective FPGA 330, 331. The FPGA circuitry parses the cell 200, which results in an associated stream identifier 402 that is specified in the header 201 of the cell 200. In a specific embodiment, the stream identifier 402 is a concatenation of the binary ATM VP/VC pair present in the header of every data cell 200. The process polls the CAM 332 to determine 403 if the stream identifier 402 of the current cell matches a value that is already stored in one of the entries of the CAM 332. If the stream identifier 402 is already present in the CAM 332, see 404, the CAM 332 returns 405 a CAM address 406. The CAM address 406 is related to the starting address of the data block in the SRAM 334 or 336. In a specific embodiment, the CAM address 406 is an index that, when multiplied by 16, a shift 4 bits in binary, is the starting address of the data block in which the network performance data for the stream identifier 402 is stored. The process then updates 407 the network performance data into the appropriate data block of the memory element 334 or 336, and repeats 408 the process for the next cell 200.

If the stream identifier is not known 409 and does not match a value that is already stored in one of the entries of the CAM 332, it is necessary to add it to the CAM 332. The process obtains 410 a next available CAM address 411 in the CAM 332. A value of the stream identifier 402 is then stored 412 in the CAM entry specified by the next available CAM address 411. The next available CAM address 411 is related to a starting address index for one of the data blocks 340 through 345 in the first and second A and B memory elements 301 through 304 that is to contain data for the stream identifier 402 currently being processed. Therefore, the process sets 413 the valid stream bit in the configuration data. During periodic reads of the configuration data, the LLP 324 recognizes that a new stream is added and maintains the stream identifier to CAM address location relationships for later use. The process then repeats for the next cell.

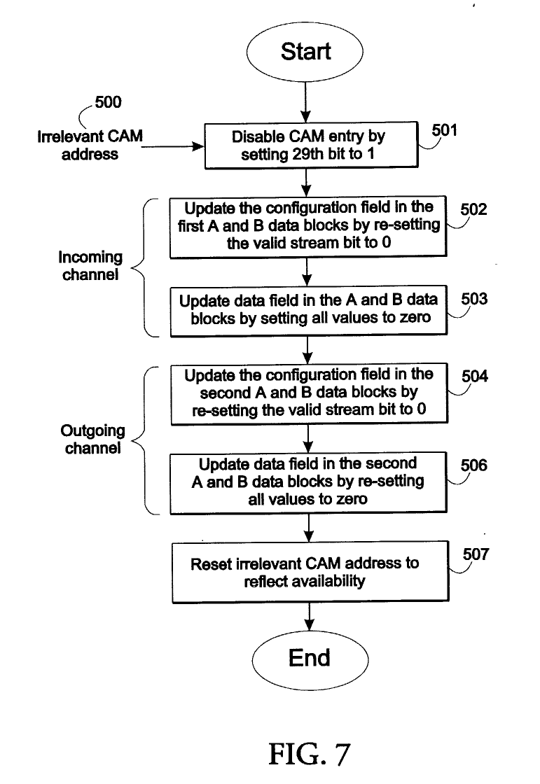

With specific reference to FIG. 7 of the drawings, there is shown an embodiment of a process for removing entries from the CAM 307 according to the teachings of the present invention. Software running in the LLP 324 determines that one or more streams have become irrelevant. The software makes this determination in a variety of ways including, but not limited to, a manual request by a user to remove a stream from being monitored and by a lack of cell traffic in a stream for some period of time. After the determination that some stream is no longer relevant to testing, the LLP 324 initiates a CAM entry deletion process, by sending an irrelevant CAM address 500 and a command to delete the irrelevant CAM address specified to the FPGA 330.

A first step in the process is to disable 501 the irrelevant CAM address 500 by setting the 29^{th} bit of the existing 28-bit entry at the irrelevant CAM address 500 to a “1” value. As one of ordinary skill in the art with reference to FIG. 5 of the drawings and the accompanying disclosure will appreciate, setting the 29^{th} bit to a “1” maintains the information in the address field 309 of the CAM 332 while assuring that the CAM address, and therefore the related data block 340 through 345, will not be reused in the process disclosed in FIG. 6 of the drawings. There is confidence that the modified entry at the irrelevant CAM address 500 will not be identified and reused in the process of FIG. 6 because allowable stream identifier values do not exceed values of (2²⁹−1). The 29^{th} bit of the CAM entry being set, therefore, masks the CAM entry during the administration process thereby protecting the corresponding data blocks from being overwritten with new data before the administration process is able to complete. The process then updates 502 the configuration information field for the data blocks in the first A and B memory elements 301, 302 by re-setting the valid stream bit to reflect invalid data. The process then resets 503 the corresponding data field in the data blocks in the first A and B memory elements 301, 302 to a zero value. The process then performs similar steps for the second A and B memory elements 303, 304 corresponding to the same irrelevant CAM address 500. Specifically, updating 504 the configuration information field 312 for the data blocks in the second A and B memory elements 303, 304 by re-setting the valid stream bit to reflect invalid data. The process then resets 506 the corresponding data field to a zero value for the second A and B memory elements 303 and 304. When the appropriate entries for both the first and second, A and B memory elements 301 through 304 have been initialized to a zero value with reset valid stream bits in the respective configuration fields, the entry in the CAM 332 corresponding to the irrelevant CAM address 500 is reset 507 to reflect future availability.

Embodiments of the invention are described herein by way of example and are intended to be illustrative and not exclusive of all possible embodiments that will occur to one of ordinary skill in the art with benefit of the present teachings. Specifically, the teachings may be applied to any data network, not just ATM, in which continuous and real time data collection is beneficial. Specifically, the teachings of the present invention may be applied to a transmission control protocol (“TCP”) by one of ordinary skill in the art. In a TCP embodiment, the “cell” is referred to in the industry as a “packet”. The method may be implemented in a different combination of hardware and software. In a specific embodiment the CAM and A and B memory elements are not part of the FPGA. As FPGAs become faster, larger and more cost-effective, it may become advantageous for the CAM and the A and B memories to become a part of the FPGA.

1. A method of administering memory resources in a data network tester comprising the steps of:
parsing a cell to obtain a stream identifier,
calculating network performance data from information in said cell,
storing said stream identifier in a content addressable memory (CAM) at a next available CAM address,
storing said network performance data in a memory element at an address in said memory element that is related to a value of said next available CAM address.

2. A method of administering as recited in claim 1 and further comprising the steps of
determining that said stream identifier is no longer relevant,
obtaining an irrelevant CAM address wherein an entry at said irrelevant CAM address contains a value matching said stream identifier,
storing a value at said irrelevant CAM address of a sum of said stream identifier and a mask value,
resetting entries in said memory element at addresses that are related to a value of said CAM address, and
resetting said irrelevant CAM address to reflect future availability.

3. A method as recited in claim 1 and repeating said steps for multiple sequential ones of said cell.

4. A method as recited in claim 2 wherein said stream identifier is twenty-eight (28) bits and said mask value is 2²⁸.

5. A method as recited in claim 1 wherein said cells are cells in an asynchronous transfer mode (ATM) network.

6. A method as recited in claim 1 wherein said cells are cells in a transfer control protocol (TCP) network.

7. A method as recited in claim 1 wherein said memory element is logically separated into A and B memory elements wherein network performance data is alternately stored in said A and B memory elements.

8. An apparatus for storing network performance data comprising:
means for parsing a cell to obtain a stream identifier,
means for calculating network performance data from information in said cell,
a content addressable memory (CAM)
means for storing said stream identifier in said CAM at a next available CAM address,
a memory element,
means for storing said network performance data in said memory element at an address in said memory element that is related to a value of said next available CAM address.

9. An apparatus as recited in claim 8 and further comprising
means for determining that said stream identifier is no longer relevant,
means for obtaining an irrelevant CAM address wherein a CAM entry at said irrelevant CAM address contains a value matching said stream identifier,
means for storing a value in said CAM entry of a sum of said stream identifier and a mask value,
means for resetting entries in said memory element at addresses that are related to said CAM address, and
means for resetting said CAM address to reflect future availability.

10. An apparatus as recited in claim 8 and further comprising means for repeating said steps for multiple sequential ones of said cell.

11. An apparatus as recited in claim 9 wherein said stream identifier is twenty-eight (28) bits and said mask value is 2²⁸.

12. An apparatus as recited in claim 8 wherein said cells are a plurality of cells in an asynchronous transfer mode (ATM) network.

13. An apparatus as recited in claim 8 wherein said cells are a plurality of cells in a transfer control protocol (TCP) network.

14. A method of administering memory resources in a data network tester comprising the steps of:
parsing a cell to obtain a stream identifier,
calculating network performance data from information in said cell,
storing said stream identifier in a content addressable memory (CAM) at a next available CAM address,
storing said network performance data in a memory element at an address in said memory element that is related to a value of said next available CAM address,
obtaining an irrelevant CAM address wherein an entry at said irrelevant CAM address contains a value matching said stream identifier,
storing a value at said irrelevant CAM address of a sum of said stream identifier and a mask value,
resetting entries in said memory element at addresses that are related to a value of said CAM address, and
resetting said irrelevant CAM address to reflect future availability.

15. A method as recited in claim 14 and repeating said steps for multiple sequential ones of said cell.

16. A method as recited in claim 14 wherein said cells are a plurality of cells in an asynchronous transfer mode (ATM) network.

17. A method as recited in claim 14 wherein said cells are a plurality of cells in a transfer control protocol (TCP) network.
